(19) United States
(12) Patent Application Publication
(10) Pub. No.: US 2008/0293357 A1
(43) Pub. Date: Nov. 27, 2008

(54) WIRELESS HAND-HELD MULTIMEDIA PLAYER AND METHOD THEREOF

(75) Inventors: Chih-Han Chien, Taipei City (TW); Chao-Jui Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/041,675

(22) Filed: Mar. 4, 2008

(30) Foreign Application Priority Data
May 25, 2007 (TW) 96118852

(51) Int. Cl. H04H 40/00

(52) U.S. Cl. 455/3.06

(57) ABSTRACT

A wireless hand-held multimedia player and a method thereof are provided. The wireless hand-held multimedia player includes a wireless network module, a multimedia playing unit, a data process module, and a control unit. The multimedia playing unit is used for playing multimedia data. The data process module is coupled to the wireless network module and the multimedia playing unit for controlling, managing, and processing the data received by the data process module. The control unit is coupled to the wireless network module and the data process module for controlling the data process module to control, to manage, and to process the data received by the data process module according to operation command from a user. Furthermore, the control unit decides whether to start the wireless network module to link a predetermined terminal according to operation command from the user, so as to access data.

### CROSS-REFERENCE TO RELATED APPLICATION

This application claims the priority benefit of Taiwan application serial no. 96118852, filed on May 25, 2007. The entirety the above-mentioned patent application is hereby incorporated by reference herein and made a part of specification.

### BACKGROUND OF THE INVENTION

1. Field of the Invention

The present invention relates to a hand-held multimedia player and a method thereof, and in particular, to a wireless hand-held multimedia player and a method thereof.

2. Description of Related Art

A general handheld multimedia player can only play multimedia data stored in a storage space of the player, or play the multimedia data stored in a memory card. If a player can be produced for remotely accessing and directly playing the multimedia data stored in a personal computer or a server, the storage space can be saved considerably, and a user can extend the storage space to the personal computer or the server. Moreover, the user does not need to download the multimedia data to the player first before watching the multimedia data every time. Therefore, the kind of player is more convenient.

FIG. 1 is a circuit block diagram of a conventional wireless multimedia playing system disclosed in the R.O.C. patent no. I267312. The wireless multimedia playing system includes a multimedia equipment 10 and a multimedia center 11. The multimedia center 11 is used for providing multimedia data. The multimedia equipment 10 accepts the multimedia data provided by the multimedia center 11 through a wireless network 100, and plays the multimedia data.

The multimedia center 11 further includes a signal transmission module 110 capable of transmitting data through the wireless network 100 and a signal process module 111. The multimedia equipment 10 includes an input interface 101, a signal selection module 102, a signal transmission module 103, a signal process module 104, a signal output module 105 and an audio-video playing unit 106. The input interface 101 is used for inputting an instruction of accepting the designated multimedia data. The signal selection module 102 is used for selecting a signal source corresponding to the multimedia data according to the inputted demand. The signal transmission module 106 is used to transmit signals to the multimedia center 11 through the wireless network 100 according to the signal source selected by the signal selection module 102, and thereby the multimedia center 11 outputs the corresponding multimedia data. The signal process module 104 is used for processing the multimedia data received by the signal transmission module 103, so as to generate voice signals or image signals. The signal output module 105 is used to output the voice signals or image signals generated by the signal process module 104. Of course, the signal output module 105 must include a voice-signal output module 1050 and an image-signal output module 1051. The audio-video playing unit 106 is used to accept and play the voice signals or image signals outputted by the signal output module 105.

In light of the above, the wireless multimedia playing system disclosed above can merely play the multimedia data, which can not satisfy consumers' demands such as remote data sharing, managing non-media files, simultaneously editing/processing the data, or etc. Moreover, the multimedia center 11 needs the signal process module 111 to function, and thereby the multimedia equipment 10 only functions near the multimedia center 11. Therefore, a mobile range of the multimedia equipment 10 is limited.

### SUMMARY OF THE INVENTION

The present invention is directed to a wireless hand-held multimedia player capable of providing functions of remote data sharing, managing non-media files and simultaneously editing/processing data.

The present invention is further directed to a wireless hand-held multimedia player which has a mobile range larger than a conventional wireless multimedia playing system does.

The present invention is still directed to a method of playing multimedia data and reading data for a wireless hand-held multimedia player. By using the method, the wireless hand-held multimedia player can have functions of remote data sharing, managing non-multimedia files, and simultaneously editing/processing data.

The present invention is further directed to a method of playing multimedia data and reading data for a wireless hand-held multimedia player. By using the method, a mobile range of the wireless hand-held multimedia player is larger than that of a conventional wireless multimedia playing system.

Based on the above-mentioned and other objectives, the present invention provides a wireless hand-held multimedia player. The wireless hand-held multimedia player includes a wireless network module, a multimedia playing unit, a data process module, and a control unit. The multimedia playing unit is used for playing multimedia data. The data process module is coupled to the wireless network module and the multimedia playing unit for controlling, managing and processing data received by the data process module. The control unit is coupled to the wireless network module and the data process module for controlling the data process module to control, manage, and process the data received by the data process module according to operation command from a user. Furthermore, the control unit decides whether to activate the wireless network module to link a predetermined terminal for accessing data according to operation command from the user.

Based on the above-mentioned and other objectives, the present invention provides a method of playing multimedia data and reading data for a wireless hand-held multimedia player. The method includes steps as follows. First, a wireless network is activated. Then, a network connection to a predetermined terminal is established. Next, a table of contents in a virtual data system is read. After that, a selected data in the table of contents is read. Thereafter, the selected data is processed according to the format of the selected data.

According to one embodiment of the present invention, the wireless network module includes a wireless transmission module and a network module. The wireless transmission module is coupled to the data process module. The network module is coupled to the wireless transmission module and the control unit for controlling the wireless transmission module to link the predetermined terminal for transmitting data.

According to one embodiment of the present invention, the wireless hand-held multimedia player further includes a data determination module. The data determination module is coupled between the data process module and the multimedia playing unit, and is coupled to the control unit, so as to determine whether an output of the data process module is a multimedia data or not, wherein if the determination is positive, the data determination module transmits the data to the multimedia playing unit for playing the data; if the determination is negative, the data determination module transmits the data to the control unit, so that the control unit executes an operation on the data transmitted by the data determination module according to operation command from the user, and thereby an execution result is obtained for controlling the data process module to control and manage the data according the execution result.

According to one embodiment of the present invention, the wireless hand-held multimedia player further includes a virtual data system. The virtual data system is used for storing link paths of the shared data of the predetermined terminal.

The present invention utilizes the network module and the data process module in the wireless hand-held multimedia player, wherein the data process module can control, manage and process the data received by the data process module. In addition, the present invention utilizes the virtual data system installed in the wireless hand-held multimedia layer. Therefore, the wireless hand-held multimedia player can have the functions of remote data sharing, managing the non-multimedia files, and simultaneously editing/processing the data, so as to achieve the effect similar to that of performing resource sharing by using the network neighborhood. Moreover, because computers or servers used for providing the shared data do not need to process signals, a signal process module is not required, and thereby a mobile range of the wireless hand-held multimedia player is larger than that of a conventional wireless multimedia player. In other words, according to the present invention, if the computers or the servers are authorized for sharing the data, a network connection to the computers and the servers can be established for using the shared data.

In order to the make the aforementioned and other objects, features and advantages of the present invention comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram of a conventional wireless multimedia playing system.

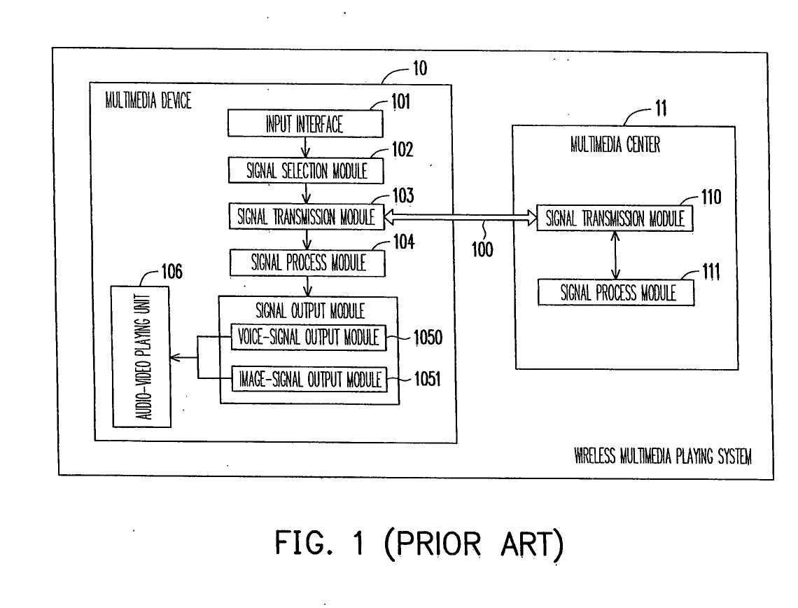

FIG. 2 is a schematic circuit block diagram of a wireless hand-held multimedia player 200 according to one embodiment of the present invention.

FIG. 3 is a schematic view illustrating point-to-point wireless transmission between the wireless hand-held multimedia player and a terminal.

FIG. 4 is a schematic view illustrating sharing the data in a LAN constituted by the wireless hand-held multimedia player and two terminals according to one embodiment of the present invention.

FIG. 5 is a schematic view illustrating sharing the data between the wireless hand-held multimedia player and the terminal in the Internet according to one embodiment of the present invention.

FIG. 6 is a schematic view illustrating sharing the data among the wireless hand-held multimedia player and the terminals in the Internet according to another embodiment of the present invention.

FIG. 7 is a schematic view illustrating sharing the data between the wireless hand-held multimedia player and the terminal in the Internet according to still another embodiment of the present invention.

FIG. 8 is a schematic view illustrating sharing the data among the wireless hand-held multimedia player and the terminals in the Internet according to still another embodiment of the present invention.

FIG. 9 is a schematic view illustrating sharing the data among the wireless hand-held multimedia player and the terminal in the Internet according to still another embodiment of the present invention.

FIG. 10 is an operation flow chart of setting up network connection configuration for sharing the data according to one embodiment of the present invention.

FIG. 11 is an operation flow chart of processing the data according to one embodiment of the present invention.

### DESCRIPTION OF EMBODIMENTS

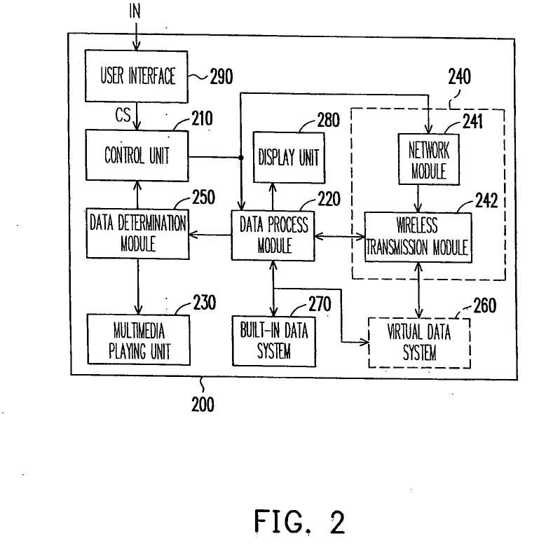

FIG. 2 is a schematic circuit block diagram illustrating a wireless hand-held multimedia player 200 according to one embodiment of the present invention. Referring to FIG. 2, the wireless hand-held multimedia player 200 mainly includes a control unit 210, a data process module 220, a multimedia playing unit 230, and a wireless network module 240. The multimedia playing unit 230 is used for playing multimedia data, and the wireless network module 240 is used for establishing a network connection to the predetermined terminal (not illustrated). The data process module 220 is coupled to the wireless network module 240 and the multimedia playing unit 230 for controlling, managing and processing data received by the data process module 220. The control unit 210 is coupled to the wireless network module 240 and the data process module 220 for controlling the data process module 220 to control, manage, and process the data received by the data process module 220 according to an operation command CS from a user. Furthermore, the control unit 210 decides whether to activate the wireless network module 240 to link a predetermined terminal for accessing the data according to the operation command CS.

The above-mentioned wireless network module 240 includes a network module 241 and a wireless transmission module 242. The wireless transmission module 242 is coupled to the data process module 220, and the network module 241 is coupled to the wireless transmission module 242 and the control unit 210, so as to control the wireless transmission module 242 to link the predetermined terminal for transmitting data.

Furthermore, the wireless hand-held multimedia player 200 further includes a data determination module 250, a virtual data system 260, a built-in data system 270, a display unit 280, and a user interface 290. The data determination module 250 is coupled between the data process module 220 and the multimedia playing unit 230, and is coupled to the control unit 210, so as to determine whether an output of the data process module 220 is a multimedia data, wherein if the determination is positive, the data determination module 250 transmits the data to the multimedia playing unit 230 for playing the data; if the determination is negative, the data determination module 250 transmits the data to the control unit 210 so that the control unit 210 executes an operation on the data transmitted by the data determination module 250 according to the operation command CS, so as to obtain an execution result for further controlling the data process module 220 to control and manage the data according the execution result. The virtual data system 260 is used for storing link paths of the shared data of a host data system 302. The built-in data system 270 is coupled to the data process module 220 for storing the data. The display unit 280 is used to display a table of contents of the built-in data system 270 and the virtual data system 260. The user interface 290 is used to receive an instruction IN inputted by the user for generating the operation command CS.

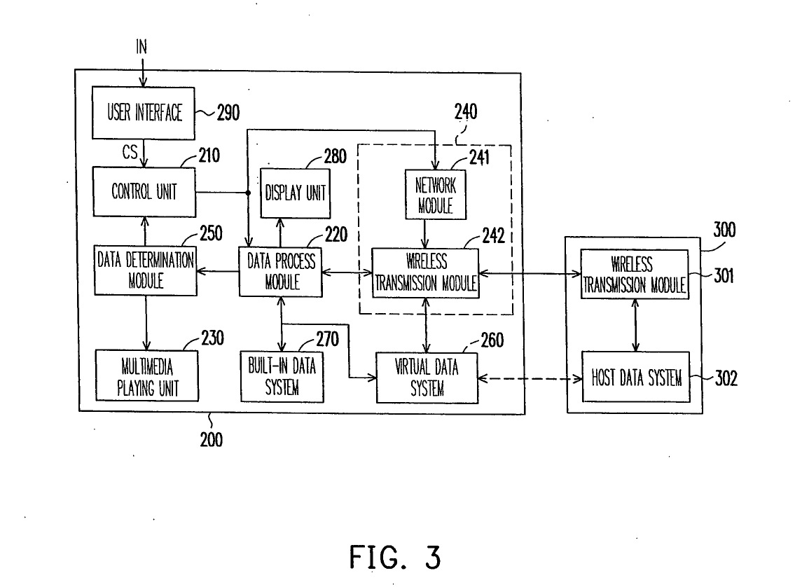

FIG. 3 is a schematic view illustrating point-to-point wireless transmission between the wireless hand-held multimedia player and the terminal according to one embodiment of the present invention, wherein the reference numeral 200 denotes the circuit blocks inside the wireless hand-held multimedia player, and the reference numeral 300 denotes the main circuit blocks inside the terminal. The terminal 300 is a general computer or a server, which mainly includes a wireless transmission module 301 and a host data system 302. The host data system 302 is used for providing the shared data.

When a user inputs the instruction IN for performing a wireless network function, the control unit 210 activates the network module 241 according to the operation command CS generated by the user interface 290. Next, the user can input the instruction IN for linking the terminal 300, so as to command the control unit 210 to control the network module 241, and thereby the network module 241 performs a linking process to link the wireless transmission module 301 in the terminal 300 through the wireless transmission module 242 in order to set up network connection configuration.

After the network connection configuration is set up, the user can browse the table of content of the shared data in the host data system 302. If the user would like to use the shared data listed in the table of content, the user can store the link path of a designated item in the table of content in order to access the shared data just like what the user does by using a web disk. Of course, the user can directly store the shared data in the built-in data system 270 for using the data. Furthermore, under the circumstance that an owner of the terminal 300 fully authorizes the access right of the shared data, the user can further utilize the virtual data system 260 to simultaneously manage the shared data in the host data system 302. In other words, the user can perform operations, such as copying or removing the data or etc., on the host data system 302. Regardless of the result of the operations, the table of contents stored in the virtual data system 260 corresponds to the table of contents of the host data system 302 on an item-to-item basis.

After the link path of the designated item in the table of contents is established in the virtual data system 260, the user can browse the table of contents in the virtual data system 260 and select the data listed in the table of contents in order to read the selected data from the host data system 302. The selected data is transmitted to the data determination module 250 through the wireless transmission module 301, the wireless transmission module 242 and the data process module 220 in sequence for determining the format of the data.

If the selected data is in a multimedia format, then the data determination module 250 directly transmits the data to the multimedia playing unit 230 for playing the data. If the selected data is not in the multimedia format, then the data determination module 250 transmits the data to the control unit 210, so that the control unit 210 executes the operation, such as copying or removing the data or the etc., on the data transmitted by the data determination module 250 according to the operation command CS from the user. Therefore, the execution result is obtained and the data process module 220 is further controlled to control and manage the data according the execution result.

According to the above-mentioned example, if the process type of the selected data is copying or removing, then the control unit 210 alters the setting of the virtual data system 260; if the process type of the selected data is storing instead of copying or removing, then the control unit 210 controls the data process module 220 to store the selected data in the built-in data system 270 after the execution result is obtained. In the aforementioned, it is assumed that the control unit 210 only determines whether the process type is copying, removing or storing. However, it is not intended to limit the present invention by the aforementioned, and the user can certainly increase the process types freely according to the actual demands. Moreover, the circuit also includes a built-in data system 270, and therefore the user can back up the data in the built-in data system 270 to the host data system 302.

In light of the above-mentioned embodiments, the network module 241 and the data process module 220 are utilized in the wireless handheld multimedia player 200, and the virtual data system 260 is also installed in the wireless handheld multimedia player 200. Therefore, the functions including remote data sharing, managing non-media files and simultaneously editing/processing the data can be performed by using the wireless handheld multimedia player 200 to achieve an effect similar to that of using the network neighborhood function. In addition, because the terminal 300 used for providing the shared data does not need to include a signal process module, the wireless hand-held multimedia player can link any terminal having a wireless transmission module in order to use the shared data in the terminal.

Based on the spirit of the above-mentioned embodiments, the present invention can be utilized in a local area network (LAN) and the Internet. Several embodiments are exemplified hereinafter.

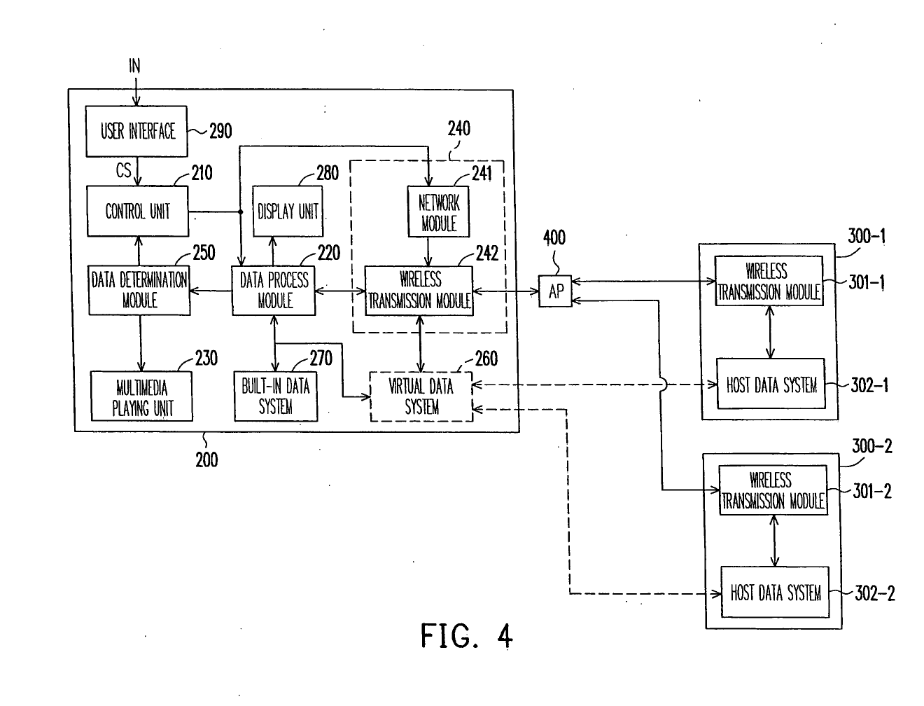

FIG. 4 is a schematic view illustrating sharing the data in the LAN constituted by the wireless hand-held multimedia player and two terminals, wherein the reference numeral 200 similarly denotes the circuit blocks inside the wireless hand-held multimedia player, and the reference numerals 300-1 and 300-2 denote the main circuit blocks inside the two terminals 300-1 and 300-2 respectively. Comparing FIG. 3 with FIG. 4, it can be found that the wireless hand-held multimedia player 200 in the FIG. 4 can link the LAN constituted by the terminals 300-1 and 300-2 through an access point (AP) 400 (i.e. a wireless station). Furthermore, under the circumstance that an owner of the terminals 300-1 and 300-2 fully authorizes the access right of the shared data, the user can further utilize the virtual data system 260 to simultaneously manage the shared data in the host data systems 302-1 and 302-2.

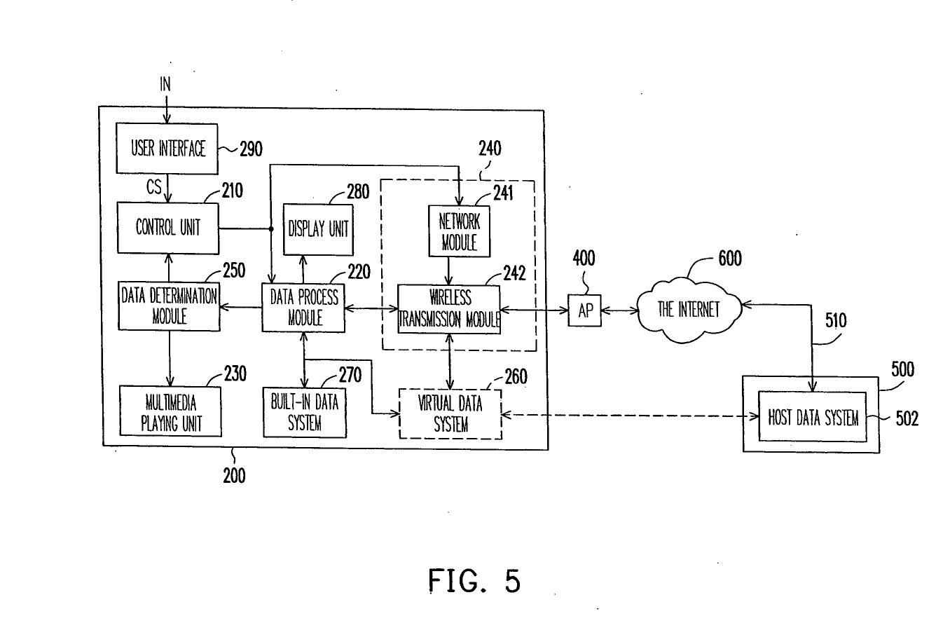

FIG. 5 is a schematic view illustrating sharing the data between the wireless hand-held multimedia player and the terminal in the Internet according to one embodiment of the present invention, wherein the reference numeral 200 denotes the circuit blocks inside the wireless hand-held multimedia player, and the reference numeral 500 denotes the main circuit blocks inside the terminal. Comparing FIG. 3 with FIG. 5, it can be found that the wireless hand-held multimedia player 200 as shown in FIG. 5 can link the terminal 500 through the access point 400, the Internet 600, and the network cable 510 in sequence. Because the terminal 500 links the Internet 600 through the network cable 510, the wireless transmission module does need to be installed in the terminal 500. Furthermore, under the circumstance that an owner of the terminal 500 fully authorizes the access right of the shared data, the user can further utilize the virtual data system 260 to simultaneously manage the shared data in the host data system 502.

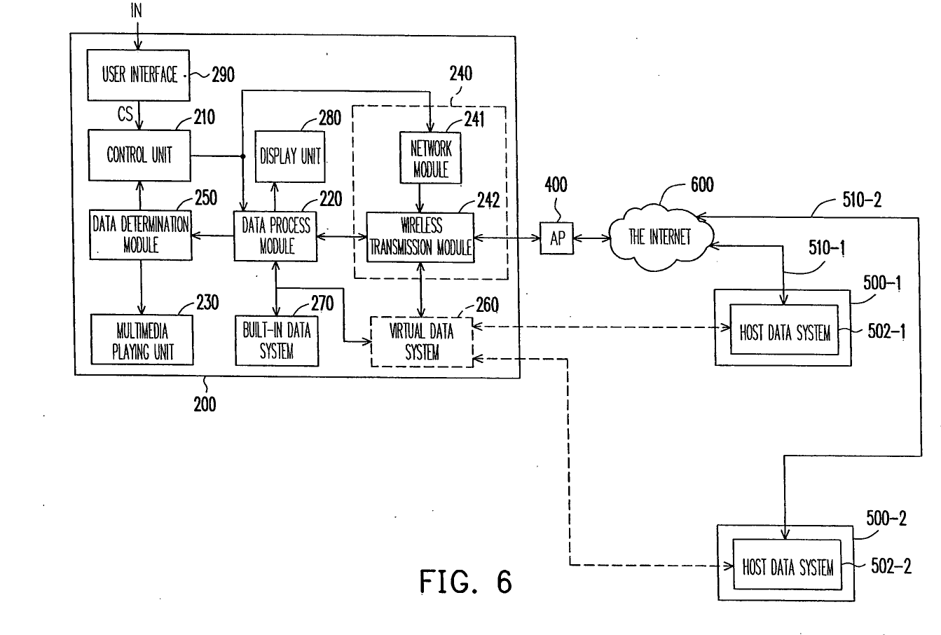

FIG. 6 is a schematic view illustrating sharing the data among the wireless hand-held multimedia player and the terminals in the Internet according to one embodiment of the present invention, wherein the reference numeral 200 denotes the circuit blocks inside the wireless hand-held multimedia player, and the reference numerals 500-1 and 500-2 denote the main circuit blocks inside the two terminals 500-1 and 500-2 respectively. Comparing FIG. 3 with FIG. 6, it can be found that the wireless multimedia player 200 as shown in FIG. 6 can link the terminal 500-1 through the access point 400, the Internet 600, the network cable 510-1 in sequence, and the wireless multimedia player 200 as shown in FIG. 6 can link the terminal 500-2 through the access point 400, the Internet 600, and the network cable 510-2 in sequence. Furthermore, under the circumstance that the owner of the terminals 500-1 and 500-2 fully authorizes the access right of the shared data, the user can further utilize the virtual data system 260 to simultaneously manage the shared data in the host data systems 502-1 and 502-2.

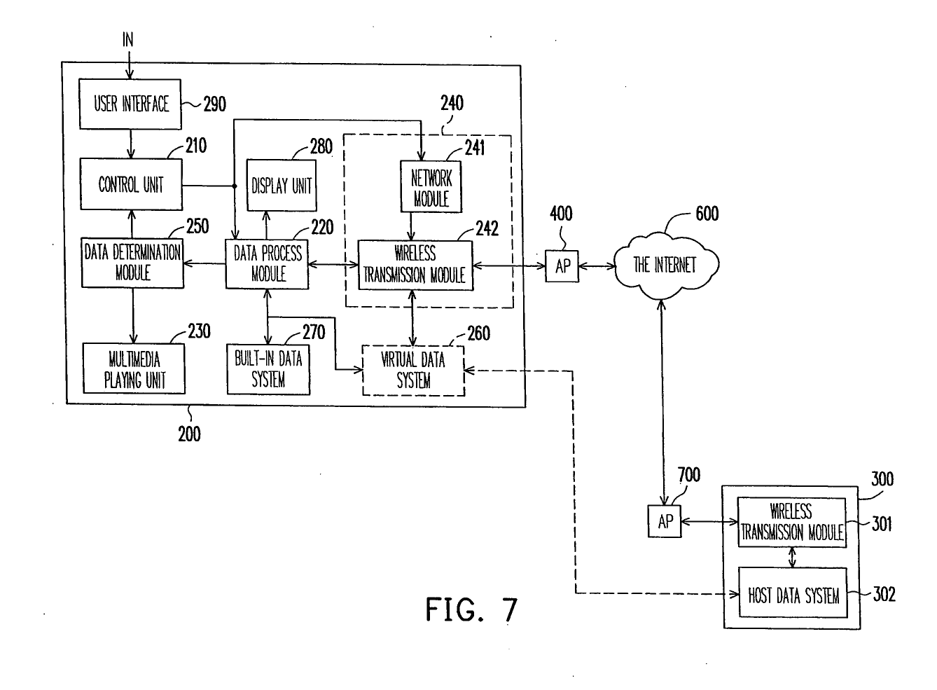

FIG. 7 is a schematic view illustrating that the Internet data sharing is performed between the wireless hand-held multimedia player and the terminal, wherein the reference numeral 200 denotes the circuit blocks inside the wireless hand-held multimedia player, and the reference numeral 300 denotes the main circuit blocks inside the terminal. Comparing FIG. 3 with FIG. 7, it can be found that the wireless hand-held multimedia player 200 as shown in the FIG. 7 can link the terminal 300 through the access point 400, the Internet 600, and the access point 700 in sequence. Furthermore, under the circumstance that the owner of the terminal 300 fully authorizes the access right of the shared data, the user can further utilize the virtual data system 260 to simultaneously manage the shared data in the host data system 302.

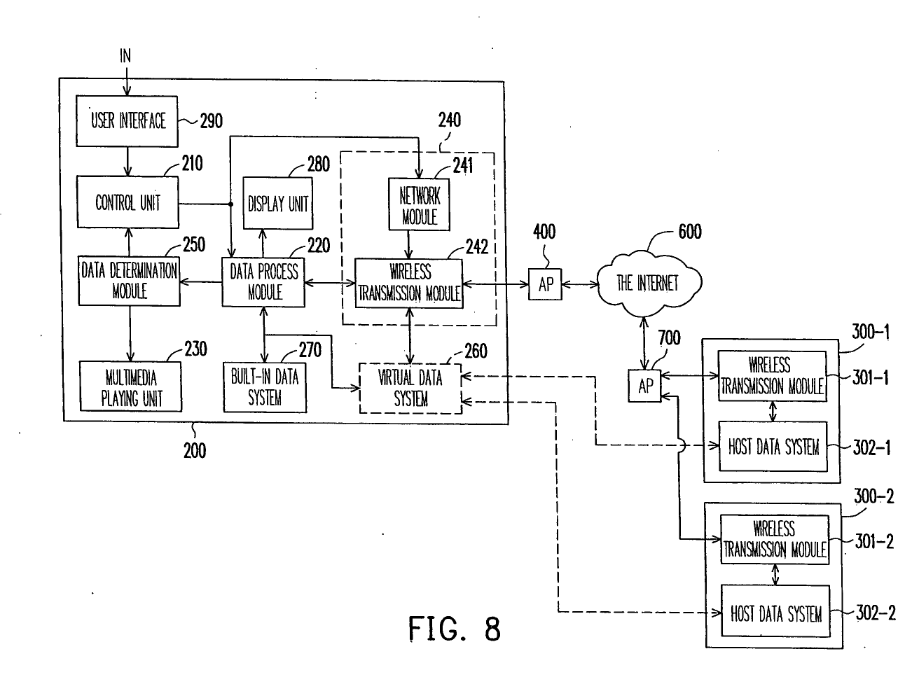

FIG. 8 is a schematic view illustrating sharing the data among the wireless hand-held multimedia player and the terminals in the Internet, wherein the reference numeral 200 denotes the circuit blocks inside the wireless hand-held multimedia player, and the reference numerals 300-1 and 300-2 denote the main circuit blocks inside the two terminals 300-1 and 300-2 respectively. Comparing FIG. 3 with FIG. 8, it can be found that the wireless hand-held multimedia player 200 as shown in the FIG. 8 can link the terminals 300-1 and 300-2 through the access point 400, the Internet 600, and the access point 700 in sequence. Furthermore, under the circumstance that the owner of the terminals 300-1 and 300-2 fully authorizes the access right of the shared data, the user can further utilize the virtual data system 260 to simultaneously manage the shared data in the host data systems 302-1 and 302-2.

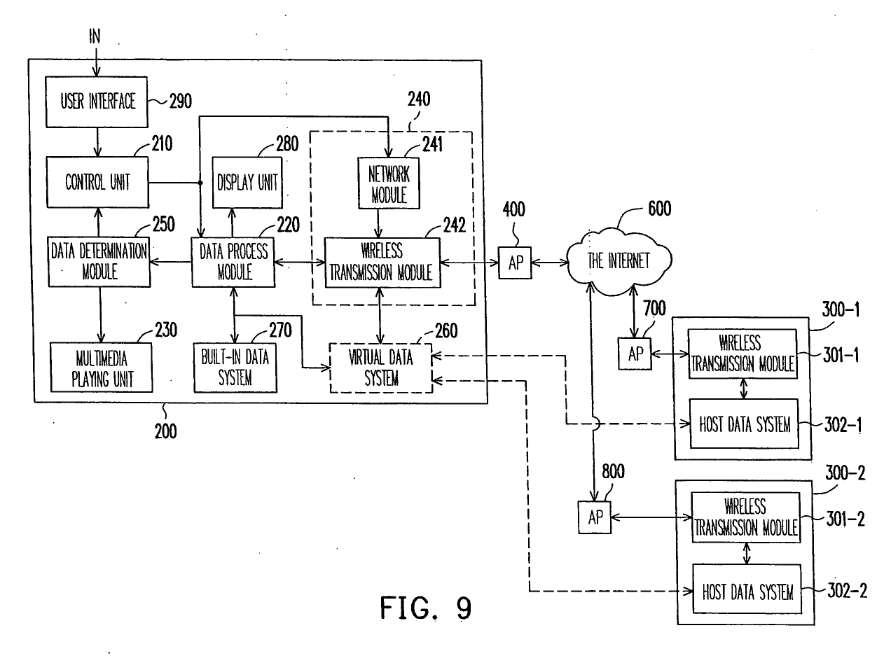

FIG. 9 is a schematic view illustrating sharing the data among the wireless hand-held multimedia player and the terminals in the Internet, wherein the reference numeral 200 denotes the circuit blocks inside the wireless hand-held multimedia player, and the reference numerals 300-1 and 300-2 denote the main circuit blocks inside the two terminals 300-1 and 300-2 respectively. Comparing FIG. 3 with FIG. 9, it can be found that the wireless multimedia player 200 as shown in the FIG. 9 can link the terminal 300-1 through the access point 400, the Internet 600, the access point 700 in sequence, and the wireless multimedia player 200 as shown in the FIG. 9 can link the terminal 300-2 through the access point 400, the Internet 600, and the access point 800 in sequence. Furthermore, under the circumstance that the owner of the terminals 300-1 and 300-2 fully authorizes the access right of the shared data, the user can further utilize the virtual data system 260 to simultaneously manage the shared data in the host data systems 302-1 and 302-2.

In the above-mentioned examples of sharing the data by using the LAN and the Internet, the user can link the designated terminal by inputting a domain name thereof to search the designated terminal or inputting an Internet Protocol (IP) address of the designated terminal. In addition, the numbers of the terminal in the above-mentioned examples are not intended to limit the present invention.

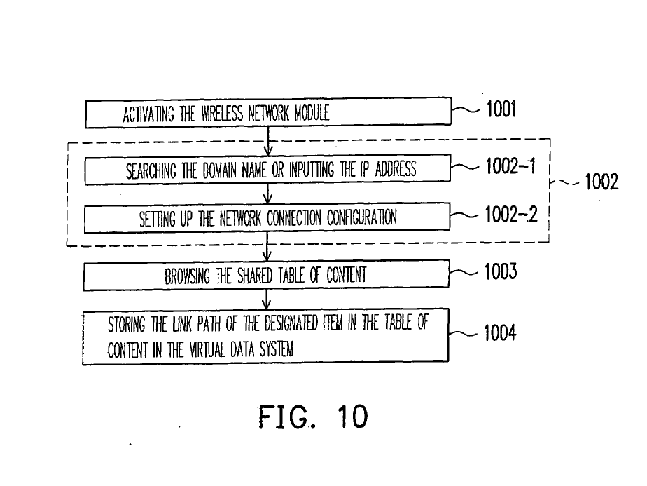

According to the above-mentioned embodiments, the basic operations of setting up the network configuration for sharing the data by using the wireless hand-held multimedia player can be sorted out as shown in FIG. 10. FIG. 10 is an operation flow chart of setting up the network configuration for sharing the data according to one embodiment of the present invention. Please refer to FIG. 10. First, the wireless network module is activated in a step 1001. Then, the network connection to a predetermined terminal is established in a step of 1002. The step 1002 is divided into steps 1002-1 and 1002-2. First, the domain name is searched or the IP address is inputted in the step 1002-1. Then, the network connection configuration is set up in the step 1002-2. After that, the shared table of content is browsed in a step 1003. Thereafter, the link path of the designated item in the table of content is stored in the virtual data system in a step 1004.

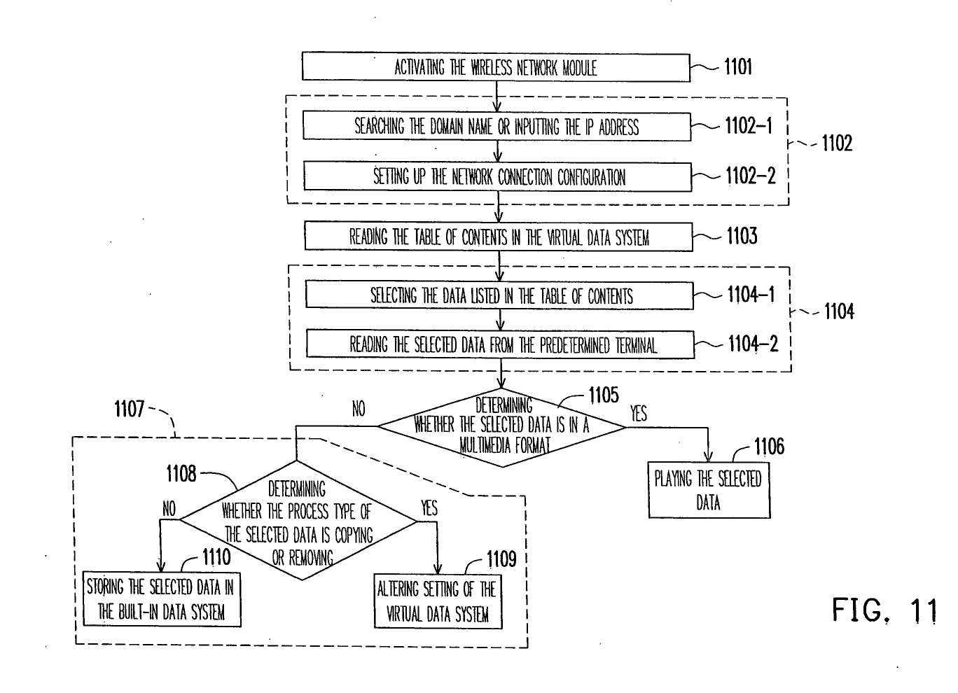

According to the above-mentioned embodiments, the basic operations of processing the data by using the wireless hand-held multimedia player can be sorted out as shown in FIG. 11. FIG. 11 is an operation flow chart of processing data according to one embodiment of the present invention. Please refer to FIG. 11. First, the wireless network module is activated in a step 1101. Then, the network connection to a predetermined terminal is established in a step 1102. The step 1102 is divided into steps 1102-1 and 1102-2. First, the domain name is searched or the IP address is inputted in the step 1102-1. Then, the network connection configuration is set up in the step 1102-2. Next, the table of contents in the virtual data system is read in a step 1103. After that, a selected data in the table of contents is read in a step 1104. The step 1104 is divided into steps 1104-1 and 1104-2. First, the data listed in the table of contents is selected in the step 1104-1. Then, the selected data is read from the predetermined terminal in the step 1104-2.

After reading the selected data in the predetermined terminal, whether the selected data is in a multimedia format is determined in a step 1105. If the determination is positive, the selected data is played in a step 1106. If the determination is negative, the selected data is processed according to the process type of the selected data in a step 1107. The step 1107 is divided into several steps. First, whether the process type of the selected data is copying or removing is determined in a step 1108. If the determination is positive, the setting of the virtual data system is altered in a step 1109. If the determination is negative, the selected data is stored in the built-in data system in a step 1110.

The operation flow chart mentioned in FIG. 11 is merely a basic example for determining whether the process type is copying, removing or storing, and is not intended to limit the present invention. The user can certainly increase the process type freely according to the actual demands.

In summary, the present invention utilizes the network module and the data process module in the wireless hand-held multimedia player, wherein the data process module can control, manage and process the data received by the data process module. In addition, the present invention utilizes a virtual data system installed in the wireless hand-held multimedia layer. Therefore, the wireless hand-held multimedia player can have the functions of remote data sharing, managing non-multimedia files, and simultaneously editing/processing data, so as to achieve the same effect as that of performing the resource sharing by using the network neighborhood. Moreover, because the computers or the servers used for sharing the data do not need to process signals, so a signal process module is not required, and thereby the mobile range of the wireless hand-held multimedia player functions is larger than that of a conventional wireless multimedia player. In other words, if the computers or the servers are authorized for sharing the data, the present invention can establish the network connection to the computers and the servers for using the shared data.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A wireless hand-held multimedia player, comprising:
a wireless network module;
a multimedia playing unit used for playing multimedia data;
a data process module coupled to the wireless network module and the multimedia playing unit for controlling, managing and processing data received by the data process module; and
a control unit coupled to the wireless network module and the data process module for controlling the data process module to control, manage, and process the data received by the data process module according to operation command from a user, wherein the control unit decides whether to activate the wireless network module to link a predetermined terminal for accessing data according to operation command from the user.

2. The wireless hand-held multimedia player according to claim 1, wherein the wireless network module comprises:
a wireless transmission module coupled to the data process module; and
a network module coupled to the wireless transmission module and the control unit for controlling the wireless transmission module to link the predetermined terminal for transmitting data.

3. The wireless hand-held multimedia player according to claim 1, further comprising:
a data determination module, coupled between the data process module and the multimedia playing unit and coupled to the control unit, for determining whether an output of the data process module is a multimedia data or not, wherein if the determination is positive, the data determination module transmits the data to the multimedia playing unit for playing the data; if the determination is negative, the data determination module transmits the data to the control unit so that the control unit executes an operation on the data transmitted by the data determination module according to operation command from the user, so as to obtain an execution result for further controlling the data process module to control and manage the data according the execution result.

4. The wireless hand-held multimedia player according to claim 1, further comprising a virtual data system used for storing link paths of the shared data of the predetermined terminal.

5. The wireless hand-held multimedia player according to claim 4, further comprising a built-in data system coupled to the data process module for storing data.

6. The wireless hand-held multimedia player according to claim 5, further comprising a display unit for displaying a table of contents of the built-in data system and the virtual data system.

7. The wireless hand-held multimedia player according to claim 1, further comprising a user interface for receiving instructions inputted by the user, so as to generate the operation command.

8. A method of playing multimedia data and reading data for a wireless hand-held multimedia player, comprising steps as follows:
activating a wireless network;
establishing a network connection to a predetermined terminal;
reading a table of contents in a virtual data system;
reading a selected data in the table of contents; and
processing the selected data according to the format of the selected data.

9. The method of playing the multimedia data and reading the data for the wireless hand-held multimedia player according to claim 8, wherein the step of establishing the network connection with the predetermined terminal comprises:
searching a domain name of the predetermined terminal or inputting an Internet Protocol (IP) address of the predetermined terminal; and
setting up network connection configuration.

10. The method of playing the multimedia data and reading the data for the wireless hand-held multimedia player according to claim 8, wherein the step of reading the selected data from the table of content s comprises:
selecting the selected data from the table of contents; and
reading the selected data from the predetermined terminal.

11. The method of playing the multimedia data and reading the data for a wireless hand-held multimedia player according to claim 8, wherein the step of processing the data according to the format of the selected data comprises:
determining whether the selected data is in a multimedia format;
playing the selected data when the selected data is in the multimedia format; and
processing the selected data according to a process type of the selected data when the selected data is not in the multimedia format.

12. The method of playing the multimedia data and reading the data for a wireless hand-held multimedia player according to claim 8, wherein when the selected data is not in the multimedia format, the step of processing the selected data according to the process type of the selected data comprises:
determining whether the process type of the selected data is copying or removing;
altering setting of the virtual data system when the process type of the selected data is copying or removing; and
storing the selected data in a built-in data system when the process type of the selected data is not copying or removing.

13. The method of playing multimedia files and reading data for a wireless hand-held multimedia player according to claim 8, further comprising:
browsing through the shared table of contents in the predetermined terminal; and
storing a designated item of contents in the virtual data system.
